(19) United States
(12) Patent Application Publication
(10) Pub. No.: US 2006/0176659 A1
(43) Pub. Date: Aug. 10, 2006

(54) Portable computer

(75) Inventors: Chen-Ming Sun, Taipei (TW); Tzu-Wei Lin, Taipei (TW); Jui-Yi Lin, Tapei (TW); Wen Tsung Huang, Taipei (TW); Chien-Hung Su, Taipei (TW); Po-Ching Huang, Taipei (TW); Yi-Kuan Lin, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/345,223

(22) Filed: Feb. 2, 2006

(30) Foreign Application Priority Data
Feb. 5, 2005 (TW) 094104101

(51) Int. Cl. G06F 1/16

(52) U.S. Cl. 361/683; 361/679

(57) ABSTRACT

A portable computer includes a host body and a cover. In this case, the host body has a containing space and at least one electronic component. The electronic component is disposed in the containing space, and the bottom of the host body is formed with an opening to expose the electronic component. The cover is removable from the host body. The cover is disposed on the host body to cover the containing space.

### BACKGROUND OF THE INVENTION

1. Field of Invention

The invention relates to a portable computer and, in particular, to a portable computer that can be easily assembled and maintained.

2. Related Art

Because laptops are convenient portable electronic devices, many people use the laptops as their movable offices. People can work anytime, anywhere as long as they carry the laptops with them. Since the sizes of the laptops are far smaller than desktop computers, the laptops become popular in mainstream market. However, due to limiting space of laptops' spatial structure, maintenance or functional upgrade of laptops are not as easy as the desktop computers.

With reference to FIG. 1A, the conventional portable computer has a stacked structure. For example, a bottom casing 12 of a host 1 is stacked with a motherboard 13, a central processing unit 18, a keyboard 14, a touch pad 15, and a top casing 11 in sequence. Then, the top casing 11 and the bottom casing 12 are locked together. Therefore, if the user wants to maintain or upgrade electronic components inside the laptop, such as the motherboard 13, the CPU 18, or the other devices on the motherboard 13, he/she has to disassemble the top casing 11, the bottom casing 12 and the internal electronic components inside the host 1 thoroughly.

With reference to FIG. 1B, for the convenience of maintenance and functional upgrade, the recent laptops are provided with holes on the bottom casing 12. Herein, the positions of the holes correspond to the positions of the electronic components that may be upgraded, such as a memory 16 and a hard disk drive 17. Also, corresponding covers 121, 121′ with each hole have to be individually formed by molding. Therefore, the manufacturing cost of the host 1 is increased. The holes on the bottom casing 12 may decrease the structural strength of the host 1, and the enhancing structure of the host 1 has to be increased. Since it is more likely for electromagnetic waves to leak out from the holes, the electromagnetic interference (EMI) control of the host 1 is not easy. Thus, more complicated designs are required in order to suppress the EMI.

Also, since DIY becomes popular, retailers and consumers want to purchase only basic equipment for laptops. Other electronic components such a s the HDD, CPU, or memory could be selected according to the preferences of consumers. Therefore, it is highly desirable to provide a portable computer that can be easily maintained or upgraded with less cost.

### SUMMARY OF THE INVENTION

In view of the above, the invention provides a portable computer that is convenient in assembly and maintenance.

To achieve the above-mentioned, the portable computer according to the embodiment of the invention includes a host body and a cover. The host body has a containing space and at least one electronic component. The electronic component is disposed in the containing space, and the bottom of the host body is formed with an opening to expose the electronic component. The cover is removable from the host body. The cover is disposed on the host body to cover the containing space.

As described above, the portable computer uses the cover to replace the bottom casing in the prior art. The user can maintain or upgrade the internal electronic devices, such as the CPU, memory, HDD, and motherboard, simply by taking off the cover. In comparison with the prior art, one does not need to remove the individual covers for the corresponding electronic devices. This design is particularly convenient for users to maintain or upgrade their portable computers.

### BRIEF DESCRIPTION OF THE DRAWINGS

The invention will become more fully understood from the detailed description given herein below illustration only, and thus is not limitative of the present invention, and wherein:

FIGS. 1A and 1B are schematic views showing a conventional portable computer;

FIG. 2 is a schematic view showing the portable computer according to a preferred embodiment of the invention; and

FIGS. 3A to 3C are schematic views showing the portable computer according to the preferred embodiment of the invention, wherein FIG. 3A is a schematic view of the keyboard module and the touch pad module, FIG. 3B is a schematic view of the support component, and FIG. 3C is a schematic view of the disposition of electronic components.

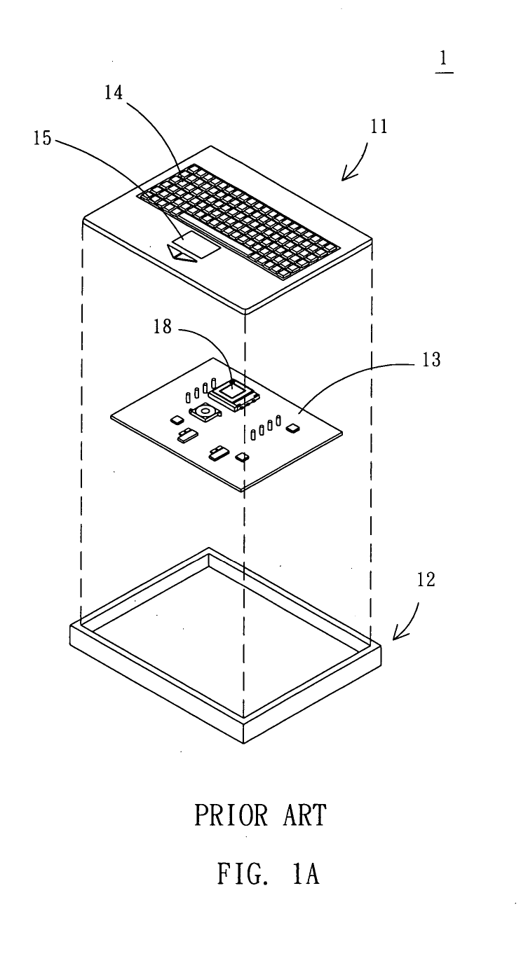

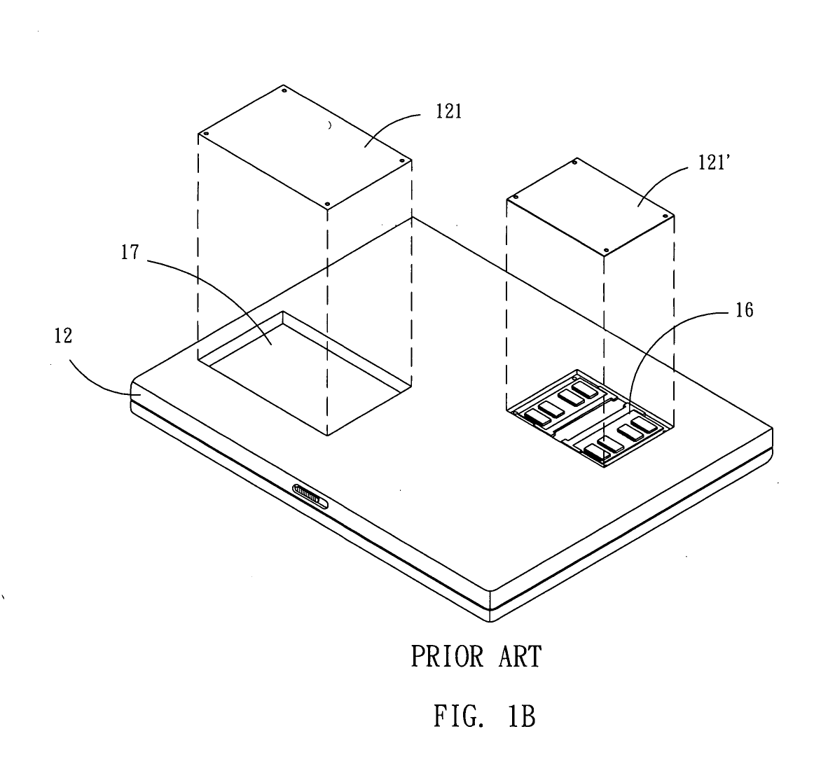

### DETAILED DESCRIPTION OF THE INVENTION

The present invention will be apparent from the following detailed description, which proceeds with reference to the accompanying drawings, wherein the same references relate to the same elements.

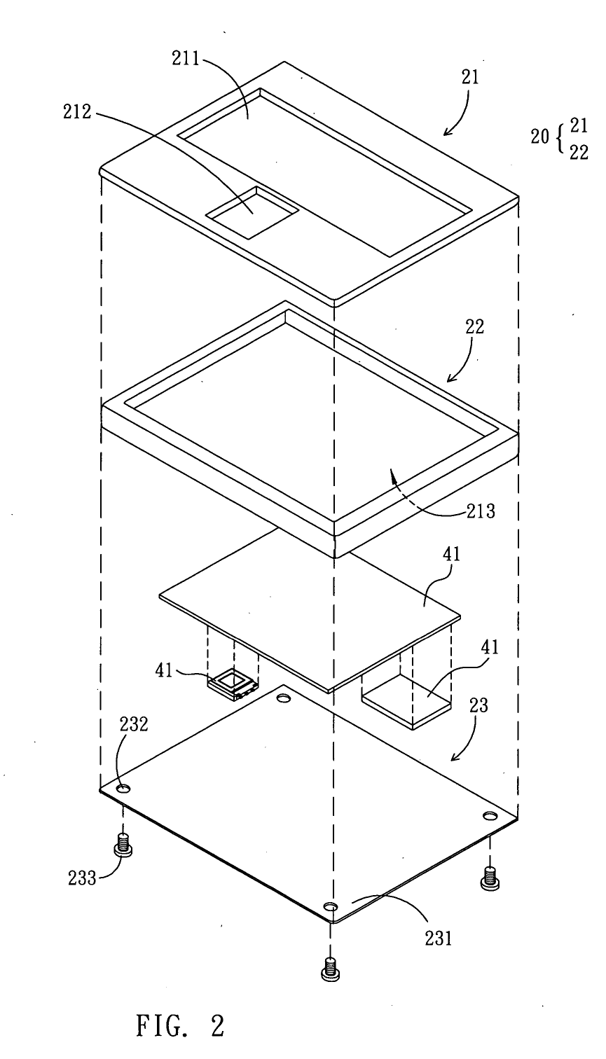

A preferred embodiment of the disclosed portable computer is illustrated in FIG. 2. The portable computer is, for example, a laptop having a host body 20 and a cover 23.

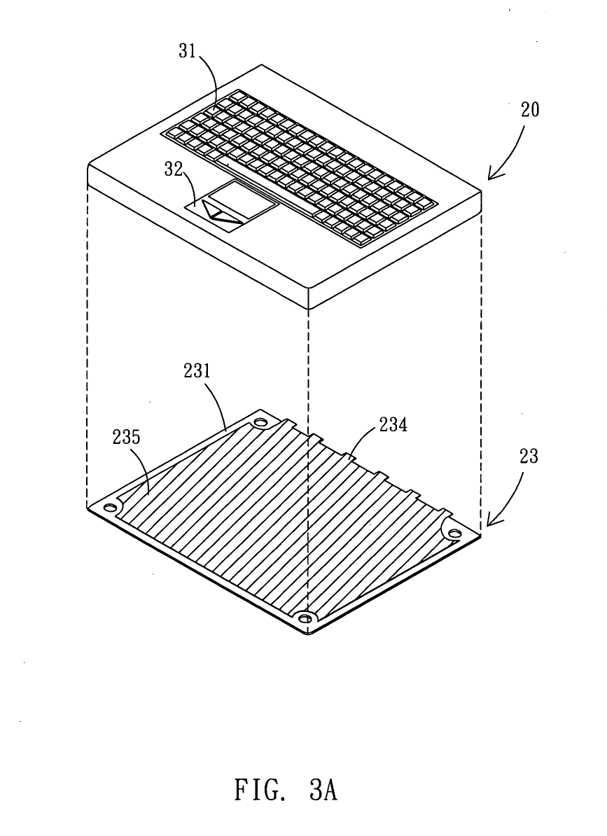

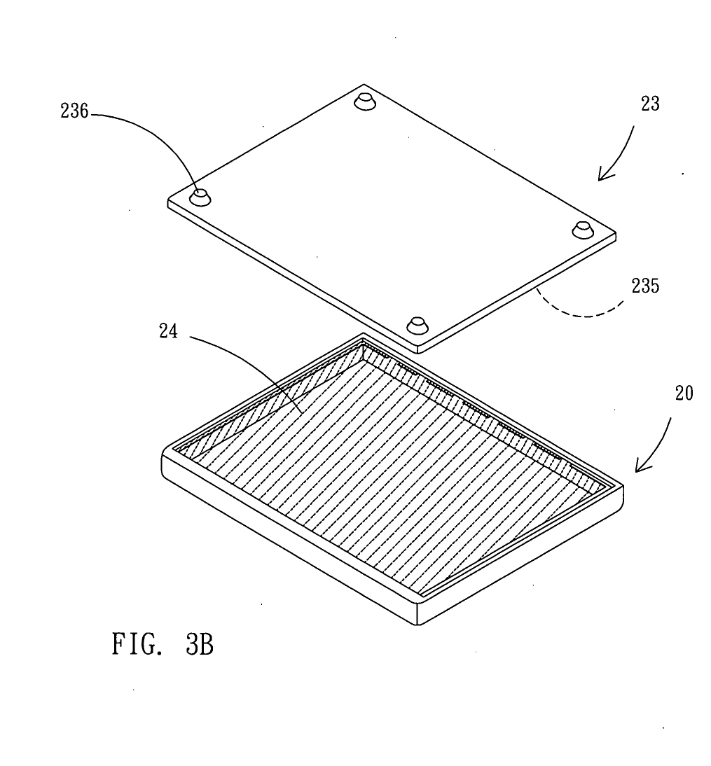

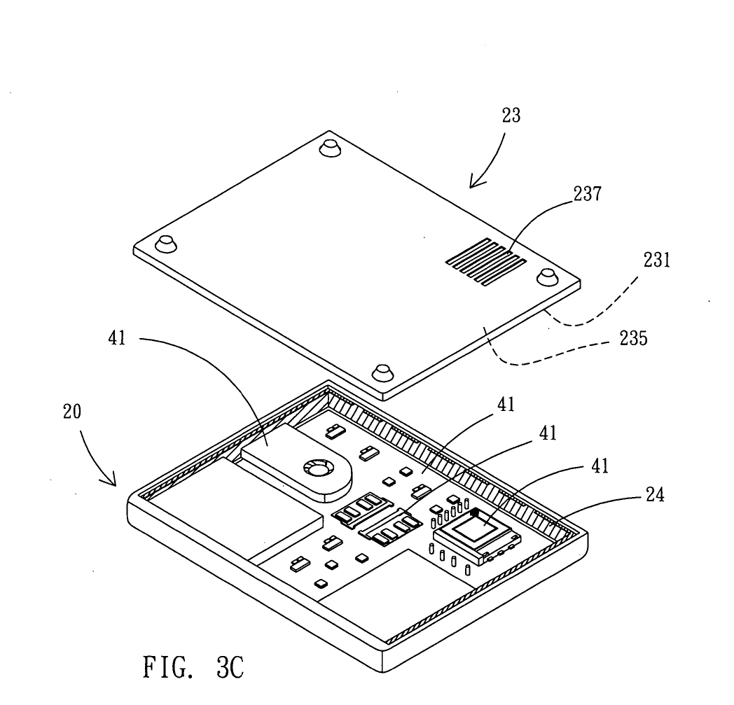

The host body 20 has a containing space and a plurality of electronic components 41, which are disposed inside the containing space. The bottom of the host body 20 is formed with a third opening 213 to expose the electronic components 41. In this embodiment, the host body 20 may consist of a top casing 21 and a frame 22. The host body 20 is further provided with a first opening 211 and a second opening 212. As shown in FIG. 3A, the first opening 211 is disposed with a keyboard module 31, and the second opening 212 is disposed with a touch pad module 32.

The cover 23 may be disposed on the host body 20 to cover the containing space, thereby forming the host of the portable computer. Once the cover 23 is taken off from the host body 20, the electronic components 41 are exposed. In this embodiment, the cover 23 has a plurality of screw holes 232. The cover 23 is combined with the host body 20 by screws 233. As shown in FIG. 3A, a plurality of locking portions 234 are formed along the sides of the cover 23 for the convenience of connection with the host body 20. In this embodiment, the cover 23 further has a first surface 231 formed with a metal layer 235 thereon. The metal layer 235 may be an iron plate. Also, the metal layer 235 may be formed by sputtering.

As shown in FIG. 3B, the portable computer in the preferred embodiment of the invention further includes a support component 24 disposed inside the containing space to increase the structural strength of the host body 20. The material of the support component 24 may be metal. In this embodiment, the material of the support component 24 is aluminum. In addition to a lighter weight, aluminum can provide a better support. The other surface of the cover 23 opposite to the first surface 231 is disposed with a plurality of rubber pads 236. When the portable computer is in use, the rubber pads 236 touch the desk to avoid sliding. Of course, the rubber pads may be substituted by footpads to achieve the same function.

As shown in FIG. 3C, the electronic components 41 in this embodiment may be disposed between the cover 23 and the support component 24. The electronic component 41 may be motherboard, CPU, HDD, optical disk drive, heat dissipating module, memory, batteries and so on. Some of the electronic components 41, such as the motherboard, may be fixed on the support component 24. The metal layer 235 formed on the first surface 231 of the cover 23 and the support component 24 form a shield to suppress the EMI produced by some of the electronic components 41. Besides, the cover 23 can be formed with a plurality of heat dissipating holes 237 for the heat source, such as at the place corresponding to the CPU. Herein, a metal net may be disposed at the heat dissipating holes 237 for suppressing the EMI.

In summary, the portable computer uses the cover to replace the bottom casing in the prior art. When the cover is taken off, the users can conveniently maintain or upgrade the internal electronic components, such as the CPU, memory, HDD, and motherboard. Also, the cover does not require additional holes that may weaken the structure. The host body further uses the support component to increase its overall structural strength. Moreover, the metal support component and the metal layer formed on the first surface of the cover provide complete EMI shielding. The invention does not need other design to suppress the EMI from holes. In addition, the cover only costs once for molding. Therefore, the cost is cheaper than the coast in the prior art.

In comparison with the conventional design, the disclosed portable computer of the invention has the following advantages:

1. The cover replaces the conventional bottom casing. It does not need an additional molding process for making holes and the corresponding covers. Therefore, the material cost is relatively reduced.

2. After the cover is taken off, the user can conveniently maintain or upgrade the internal electronic components such as the CPU, memory, HDD, and motherboard.

3. The metal support component and the metal layer formed on the cover provide better EMI suppression and support structure.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A portable computer, comprising:
a host body, which has an containing space and at least one electronic component, wherein the electronic components is disposed in the containing space, the bottom of the host body is formed with an opening to expose the electronic components; and
a cover, which is removable from the host body, wherein the cover is disposed on the host body to cover the containing space.

2. The portable computer of claim 1, further comprising:
a support component, which is disposed in the containing space to strengthen the host body.

3. The portable computer of claim 2, wherein the material of the support component is metal.

4. The portable computer of claim 1, wherein the electronic component is selected from the group consisting of a central processing unit, a hard disk drive, an optical disk drive, and a heat dissipating module.

5. The portable computer of claim 1, wherein the host body further comprises at least one opening.

6. The portable computer of claim 5, wherein a keyboard module or a touch pad module is disposed in the opening.

7. The portable computer of claim 1, wherein the host body and the cover are connected by screws.

8. The portable computer of claim 1, wherein the host body and the cover are connected by locking.

9. The portable computer of claim 1, wherein the cover further comprises has a first surface formed with a metal layer.

10. The portable computer of claim 9, wherein the metal layer is formed by sputtering.

11. The portable computer of claim 9, wherein the metal layer is an iron plate.

12. The portable computer of claim 1, wherein the host body has a lid and a frame.

13. The portable computer of claim 1, wherein the electronic component is a motherboard and the opening exposes the motherboard.
